(19) United States
(12) Patent Application Publication
(10) Pub. No.: US 2026/0103273 A1
(43) Pub. Date: Apr. 16, 2026

(54) MECHANISM FOR LOCKING A DOOR IN CIRCULAR TRANSLATION

(71) Applicant: LATECOERE, Toulouse Occitaine (FR)

(72) Inventors: Xavier Bories, Toulouse (FR); Sébastien DEVILLEZ, SAINT JEAN (FR); Stephane Quement, Toulouse (FR); Sébastien Mougenot, Graulhet (FR)

(73) Assignee: LATECOERE, Toulouse Occitaine (FR)

(21) Appl. No.: 19/115,295

(22) PCT Filed: Sep. 13, 2023
(86) PCT No.: PCT/EP2023/075114

§ 371 Date: Mar. 26, 2025

(30) Foreign Application Priority Data
Sep. 29, 2022 (FR) FR2209878

(51) Int. Cl. B64C 1/14

(52) U.S. Cl. CPC B64C 1/143

(57) ABSTRACT

A circular translation door locking mechanism (2) assembly (2), the door being of the vehicle semi-plug type. The mechanism (2) includes a handle (3) that activates a rotation of the door (1a) on itself and two guide entities of this door (1a) in circular translation: an arm entity (4a) including an arm (4b) and a forearm (4c) rotating with respect to each other and a guide entity (5a) having a connecting rod (5b) and a lever (5c) rotating with respect to each other. The locking mechanism (2) further includes at least one device for locking the lever (5c) and forearm (4c) in relation to the door (1a) as well as a locking element of the handle (3) during the circular translation of the door (1a).

### TECHNICAL FIELD

The invention relates to a locking mechanism for a circular translation moving door. More specifically, the present invention relates to semi-plug doors of passenger and/or goods transport vehicles, i.e. doors capable of passing through their frame when opening and closing. In particular, aircraft, coaches or truck cabins are intended to be equipped with such doors.

In the aeronautical field in particular, stops installed around the door and its frame make it possible to engage the door by keeping it in its frame, these stops being all the more stressed during the flight phases of the aircraft by the pressurization exerted in the cabin. Conversely, during the phases when the aircraft is stopped on the ground, the stops are disengaged in order to allow the doors to be opened. The doors and their opening/closing system are designed to be simple and quick to handle, while avoiding damaging the structure of the aircraft—in particular its fuselage—to which they are attached. After exiting the frame, the door opens in a circular translation kinematics during which the door remains parallel to the fuselage and therefore parallel to the position it occupies when closed. Similarly, during closing, the door follows a reverse circular translation kinematics before entering the frame and engaging the stops.

### PRIOR ART

Conventional mechanisms for locking moving parts on a structure, such as an aircraft door or equivalent, are implemented by resting each of these moving parts against stops, these stops being installed on the structure. Each stop ensures that the moving parts are locked in one direction, with the locking of the unlocked directions being achieved by hooks, levers, locks or cams.

A typical type of opening kinematics is to keep the door constantly parallel to the fuselage to prevent it from hitting the fuselage in the event of an emergency opening or adverse weather conditions. The step of disengaging the stops is therefore carried out by keeping the door parallel to the fuselage: to do this, the door is first raised or lowered to disengage the stops, before applying to it—to take it out of its frame—a circular translational movement, during which the door remains constantly parallel to itself when it is moved while describing a circular trajectory. Circular translation guidance is generally carried out by two connecting rods arranged in parallel and forming a parallelogram.

A major disadvantage of this system is that the flight crew has to bear the full weight of the door during the disengagement phase of the stops. Improvements to facilitate this task add additional mass compensation mechanisms and articulation arms, but these means result in a significant increase in the overall weight of the door and therefore of the aircraft.

Another opening system as described in the patent U.S. Pat. No. 2,751,636A allows to generate a door opening/closing kinematics not parallel to the fuselage. This kinematics consists of making a first pivot of the door around an axis passing through its vertical median to disengage the stops, then a second circular translation movement, called “swivelling”, of the door around an axis coinciding with a vertical edge of the frame. Such a system, which makes it possible to do away with the mass compensation mechanism and facilitates the handling of the door, remains very complex to implement because it involves a combination of connecting rods, gearboxes and pinions in large numbers, as well as an unlocking lever located near the door, and more precisely on its frame.

In addition, the first swivel to disengage the stops can be replaced by another mechanism, as described in the FR3087189 patent, which has the advantage of being operated halfway up the door directly via the door arm. However, this solution is also complex to implement.

Generally speaking, regardless of the kinematics, the swivelling phase presents risks of instability that lead to difficulties in handling the door, extended opening/closing times, as well as risks of damaging resulting from impacts of the door on the fuselage of the aircraft.

It is also known that this problem of door instability during the swivelling phase was addressed by using two rotating mobile guide rods placed at the top of the door. This method of implementation implies that the door remains permanently parallel to the fuselage, especially when the door is lowered/raised during the phases of engagement/disengagement of the stops. In addition, it is necessary to use at least two guide rods in the upper part of the door because if only one connecting rod is used, when rotating the door arm between about 110° and 135°, the line of the door arm and the connecting rod are overlapping and the kinematics become unstable.

In addition, after the door stops are disengaged by pivoting, the presence of two connecting rods stabilizes the door during the swivelling phase, but involuntary manipulation on the door handle, for example, does not prevent this door from being accidentally shifted according to uncontrolled positions. As a result of such a shift in the positioning of the door, the door no longer remains parallel to the fuselage during the swivelling phase, which leads to the risk of damage to the door and/or fuselage.

### DISCLOSURE OF THE INVENTION

The main objective of the invention is to solve the problem of locking the door with regard to the elements allowing circular translation during the swivelling phase in the context of a kinematics of exit or entry of the door not parallel to the fuselage, having the advantage of freeing itself from the vertical lifting/lowering constraint, and therefore of offering a door that is easy to handle and with reduced weight. However, the exit or entry kinematics of the door not parallel to the fuselage implies a rotation of the door, this rotation being undesired during the swivelling phase. And errors in the handling of the opening system, in particular an action on the door handle, can lead to a rotation of the door during the swivelling phase.

To hold the door parallel to the fuselage during circular translation, the invention provides for a locking of the door when it is in circular translation in combination with a locking of the door handle during circular translation.

More precisely, the present invention relates to a circular translation door locking mechanism assembly comprising a vehicle semi-plug type door and a body, in particular an aircraft fuselage, in which at least one opening making a door frame is cut. The mechanism comprises a handle which activates a rotation of the door on itself in the door frame and connects the door to the door frame by two door guide entities in circular translation, namely: an arm entity comprising an arm and a forearm rotating in relation to each other along an axis parallel to the axis of rotation of the door, the arm and forearm being connected to the door frame and the door respectively, and a guide unit having a connecting rod and a lever rotating in relation to each other on another axis parallel to the axis of rotation of the door and connected respectively to the door frame and to the axis of rotation of the arm entity, the mechanism also having at least one means of blocking the lever and forearm in relation to the door as well as a blocking element of the handle during circular translation. Thus, the mechanism locks the lever and forearm in relation to the door and blocks the handle during circular translation.

Advantageously, such a mechanism reduces the weight of the door and of its opening/closing assembly, as the door only moves in rotation and circular translation without lifting or lowering.

Also advantageously, the blocking of the lever and forearm during the circular translation phase makes it possible to block the rotation of the door by freeing itself from additional structural elements that would increase the mass of the door and the size of the opening/closing assembly.

Also advantageously, the blocking of the door handle prevents its operation, which would lead to a rotation of the door and damage to the structure of the vehicle. The combination of lever and forearm locking with handle blocking secures the door opening during circular translation, especially in the case of accidental handling of the handle or pressing on the door. As the handle is blocked, it can be used to guide the door during the circular translation without the risk of rotating the door and damaging the structure.

In accordance with some preferred embodiments:
the blocking of the lever and the forearm in relation to the door is achieved by at least two stops arranged on the door;
the blocking of the lever is achieved by the two stops arranged on the door;
the blocking of the forearm is achieved by a stop arranged on the lever;
the blocking element of the handle is achieved by a mechanical connecting handle (hereinafter called interlock) fixed in rotation on the door and against the handle during the circular translation;
a traction device engages the handle against the handle;
the traction means is a tension spring;
a handle guide ramp is installed on the arm and moves the handle stand away from the handle when the door rotates on itself in the door frame;
the handle is connected to the door by a two-sided cam which has at least one guide path on one side, and at least one prohibition wall on the other side;
the cam has two guide paths, respectively the forearm and the door;
the forearm and the door each have a roller engaged in their respective guide path;
the cam has two prohibition walls;
the arm has a roller in contact with the prohibition walls during the rotation of the door, and
the prohibition walls are separated by a space sized to allow the roller of the arm to pass through.

Advantageously, the forearm stop on the lever allows the forearm to be blocked in relation to the door by avoiding the installation of an additional stop on this door, thus saving space on the door and therefore also a faster door installation. This blocking kinematics with “cascading” stops around the lever allows the lever and the forearm to be blocked in relation to the door by putting only one lever in stop against the door.

Also advantageously, the handle locks the handle during the circular movement: the handle cannot therefore be operated during this circular rotation, its action only causes the door to rotate.

Also advantageously, the interdiction walls prevent the door arm from moving until the door is completely out of the door frame and is again parallel to the fuselage: the interdiction walls therefore make it possible to ensure that the lever and forearm are blocked when the door is in the correct orientation before the circular translation.

### DESCRIPTION OF THE FIGURES

Other features and advantages of the present invention will be apparent from the following reading of an example of a detailed embodiment without limiting its scope, with reference to the annexed figures which represent, respectively:

FIG. 1a, FIG. 1b and FIG. 1c, views of a door in circular translation in the plane of this translation at different moments;

FIG. 2, a perspective view of an aircraft door;

FIG. 3, an exploded perspective view of the arm-entity and the guide-entity;

FIG. 4, a perspective view of the interior and exterior door handles constituting the door handle;

FIG. 5, a perspective view of the guide unit and the stops on the door during the exit of the door from the door frame;

FIG. 6, a cross-sectional view of the handle connecting cam during the exit of the door from the door frame;

FIG. 7, a cross-sectional view of the cam when the door is ready to exit the door frame;

FIG. 8, a perspective view of the locking mechanism during circular translation;

FIG. 9a and FIG. 9b, a perspective view of the stand and an enlargement of that view when the door is extended from the door frame, and

FIG. 10a, FIG. 10b and FIG. 10c are successive views of the door exit from its frame.

### DETAILED DESCRIPTION

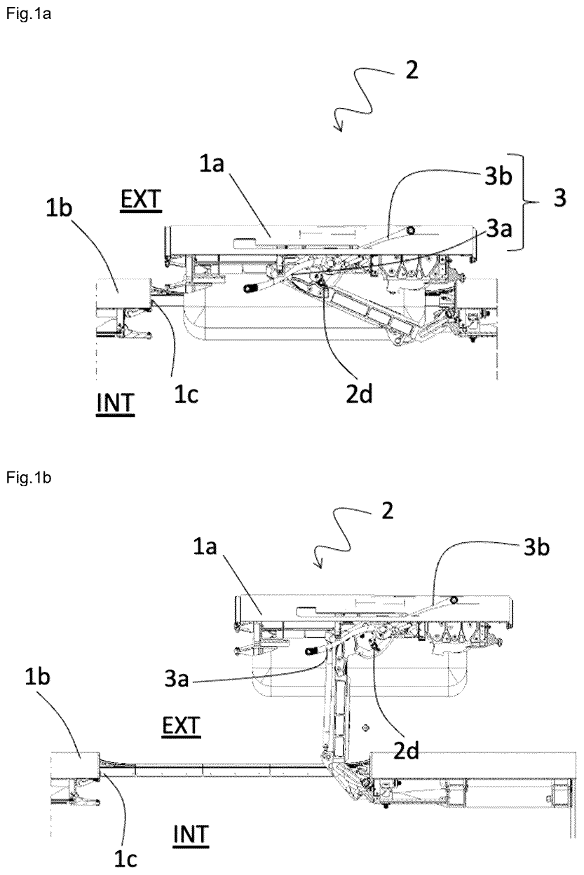

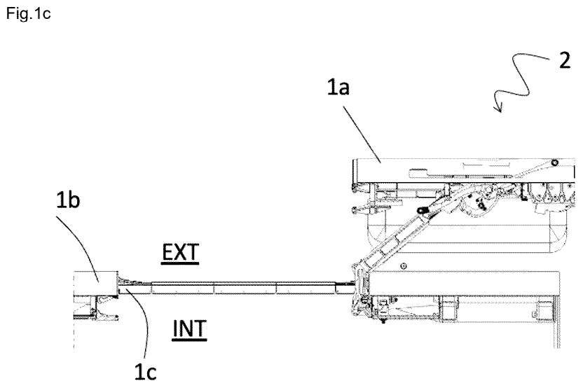

FIG. 1a, FIG. 1b and FIG. 1c illustrate the positions of a door 1a in circular translation. This aircraft door 1a is a semi-plug type and is part of a locking mechanism assembly 2 of the door 1a in circular translation. The aircraft (not shown in its entirety) also has a fuselage 1b in which an opening is cut into a door frame 1c. When door 1a is closed, it is blending with fuselage 1b and delineates the interior INT of the aircraft with the exterior EXT. Upon opening, door 1a disengages from fuselage 1b and exits fuselage 1b in a position shown in FIG. 1a, with door 1a parallel to fuselage 1b on the exterior EXT of the aircraft and continuing to close the frame.

The opening of door 1a continues in a circular translational kinematics during which door 1a remains parallel to fuselage 1b, as shown in the intermediate position in FIG. 1b, to reach the final opening position in FIG. 1c. The closing of door 1a is carried out according to an inverse kinematics: a circular translation from the open position of door 1a in FIG. 1c to the position of door 1a in FIG. 1a. Door 1a is then facing door frame 1c and engages in fuselage 1b.

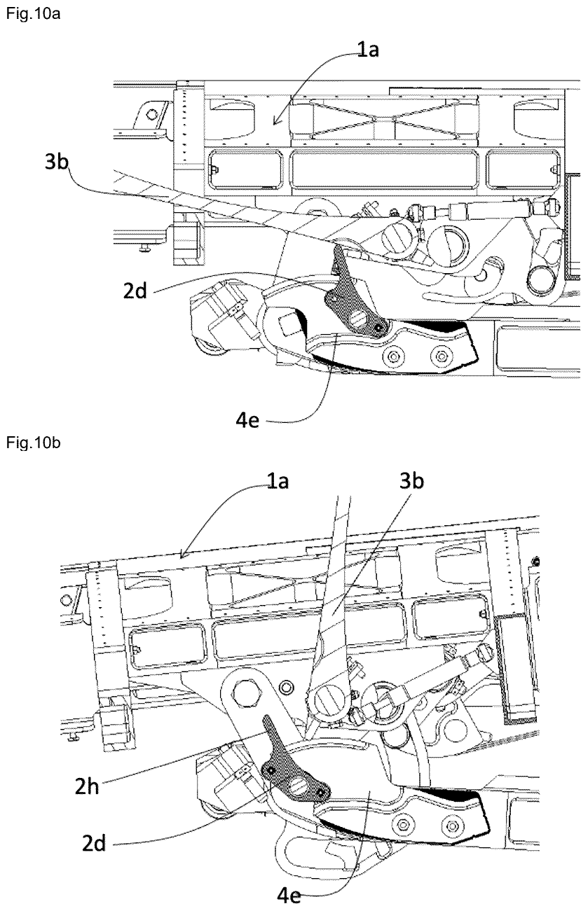

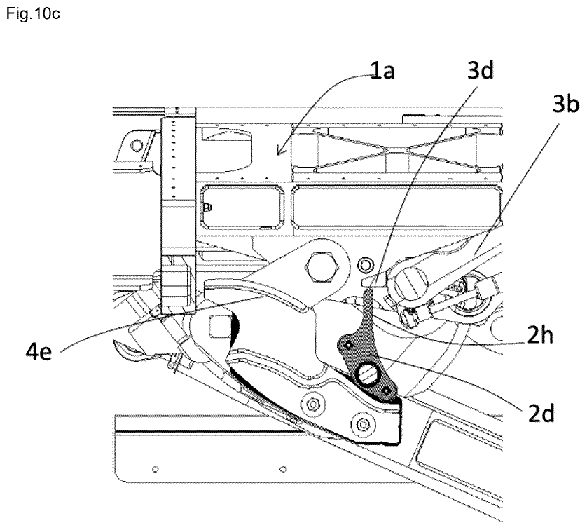

The engagement/disengagement of door 1a from fuselage 1b is achieved here by a rotation of door 1a as shown successively in FIG. 10a, FIG. 10b and FIG. 10c, this rotation being controlled by the door handle 3 composed of an inner handle 3a and an outer handle 3b. The inner 3a and outer 3b handles are advantageously diametrically opposed to each other: this configuration makes it possible to engage/disengage door 1a according to the same handle kinematics from the interior INT or the exterior EXT of the aircraft by operating the inner handle 3a or the outer handle 3b respectively. During the circular translation, the inner handles 3a and outer handles 3b are blocked by a 2d handle and therefore immobile in rotation with respect to the door 1a.

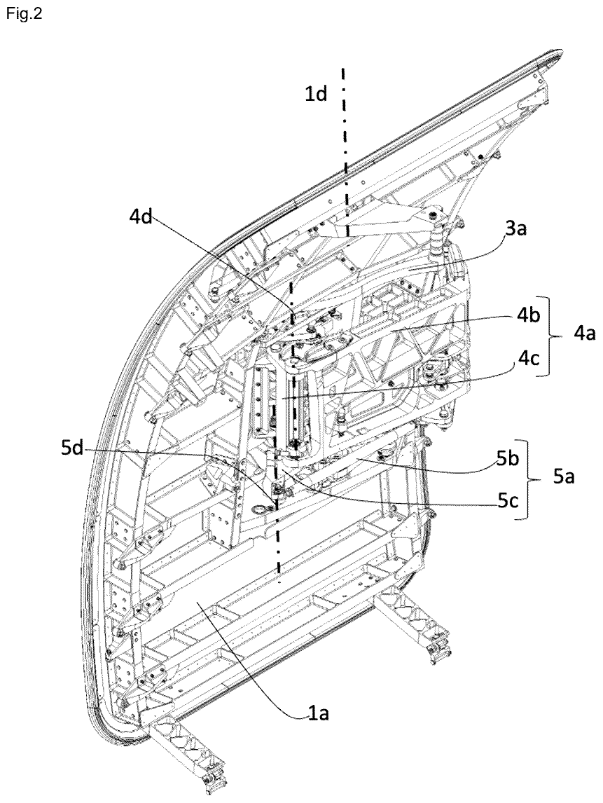

FIG. 2 shows more precisely an aircraft door 1a equipped with an inner handle 3a which activates a rotation along an axis 1d of door 1a on itself in the door frame 1c, door 1a being connected to this frame 1c by two guide entities of door 1a in circular translation, namely: an arm entity 4a, comprising an arm 4b and a forearm 4c rotating by each other along a 4d axis parallel to the 1d axis of rotation of door 1a, arm 4b and forearm 4c being connected to door frame 1c and door 1a respectively; and a guide unit 5a, comprising a connecting rod 5b and a lever 5c rotating with respect to each other on another 5d axis parallel to the 1d axis of rotation of the door and connected respectively to the door frame 1c and the 4d axis of rotation of the 4c arm entity.

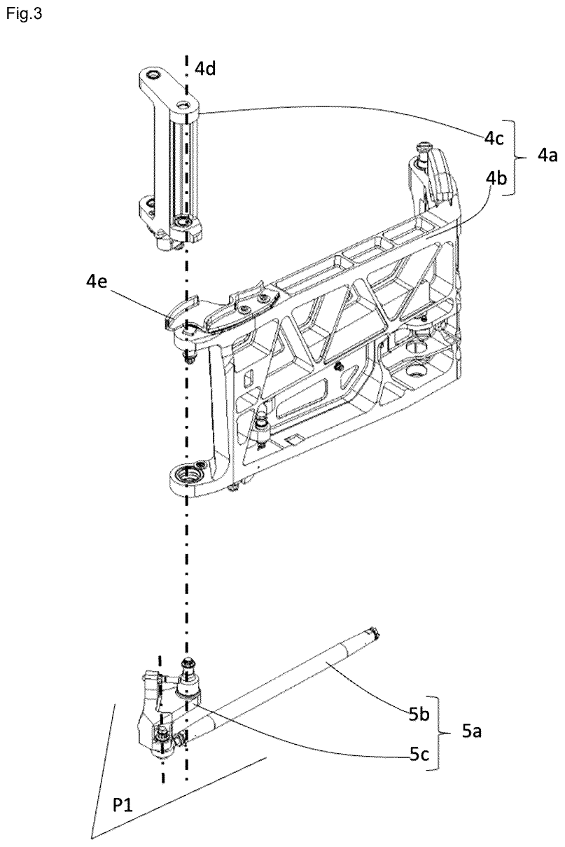

Arm entity 4a and guide entity 5a are shown in more detail in the exploded view in FIG. 3. The arm entity 4a drives the door 1a when it opens and closes by circular translation. Arm 4b has a reinforced structure to support the mass of door 1a as well as a 4e ramp for guiding the stand 2d. The guide unit 5a is juxtaposed to the arm unit 4a, parallel to the arm 4b: the guide unit 5a thus ensures the stability of the circular translation kinematics of door 1a. The connecting rod 5b and lever 5c of the guide unit 5a move in the plane P1 perpendicular to the axis 4d of rotation.

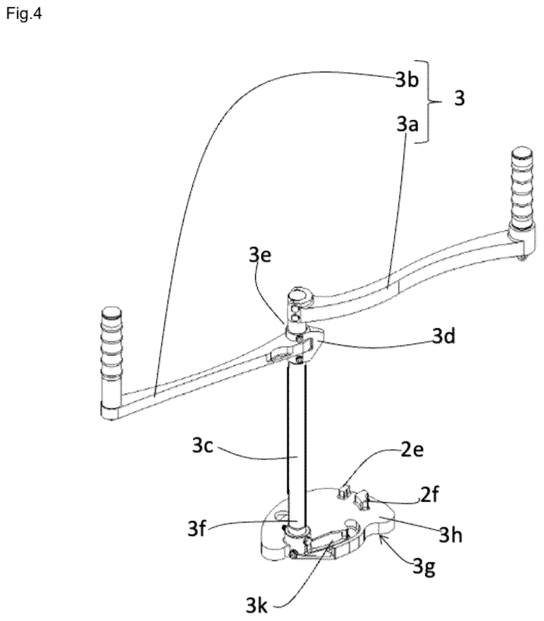

FIG. 4 shows the door handle 3 consisting of an inner handle 3a that can be operated from the interior INT of the aircraft and an outer handle 3b that can be operated from the exterior EXT of the aircraft, with door 1a that can be opened or closed from the interior INT and/or the exterior EXT of the aircraft. The two handles 3a, 3b are integral to each other and fixed at an end 3e of a rotating axis 3c, this axis 3c transmitting the rotation of any one of the handles 3a, 3b to door 1a.

At the other end 3f of the 3c axis of rotation is a cam 3g which connects—through the length of the axis 3c of rotation—the handles 3a, 3b to door 1a. This cam 3g has two sides and has on one side 3h two prohibition walls 2e, 2f, which allow the door to be completely disengaged, as will be explained later. This H side 3h also features the 3K forearm guide path. In addition, in this example illustrated, the outer handle 3b has a handle stand 3d in the vicinity of the axis of rotation 3c: the handle 2d then rests against this handle stand 3d during the circular translation of door 1a, thus blocking the rotation of handles 3a, 3b and consequently the rotation of door 1a during the circular translation. Alternatively, the handle stand can be present on the inner handle 3a or at any point on the 3c axis depending on the position of the handle stand 3d.

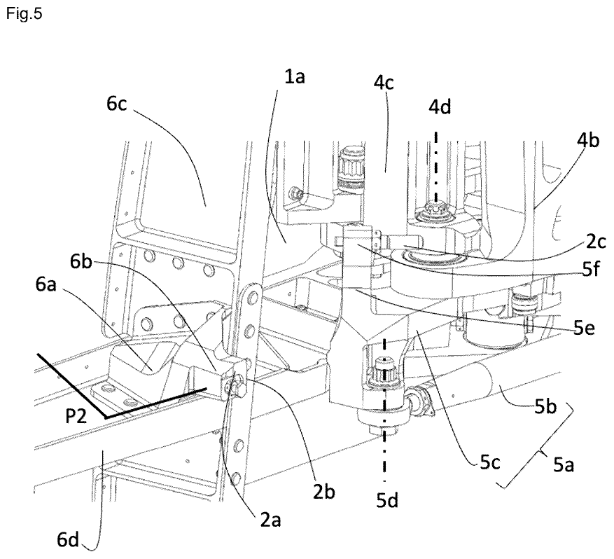

A portion of door 1a with its locking mechanism 2 during the engagement/disengagement of door 1a is more precisely shown in FIG. 5 in which arm 4b and forearm 4c appear assembled in rotation with respect to each other along a 4d axis parallel to the 1d axis of rotation of the door. Similarly, lever 5c and connecting rod 5b are assembled in rotation with respect to each other on another 5d axis also parallel to the 1d door rotation axis. In addition, lever 5c is also connected to the forearm 4c and rotates with respect to it along the 4d axis of rotation between arm 4b and forearm 4c. Lever 5c is linked respectively at each of its ends to a 4d, 5d axis of rotation parallel to the 1d axis of rotation of the door: lever 5c thus moves in a plane perpendicular to this axis of rotation of the door 1d.

In order to block lever 5c in relation to door 1a, it is planned in this embodiment to arrange on door 1a, more precisely in the vicinity of guide unit 5a, a fitting 6a connected to a frame 6c and a crossbar 6d which are perpendicular to each other. This 6a fitting has an end 6b which has two perpendicular faces, each making a stop 2a, 2b arranged on the door 1a. These stops 2a, 2b have the function of blocking lever 5c with respect to door 1a: they are therefore oriented in a plane P2 which is perpendicular to the axis 4d of rotation and parallel to the plane P1 in which the lever 5c moves. When lever 5c is in contact with stops 2a, 2b on door 1a, it is blocked in two perpendicular directions belonging to its plane of travel and is therefore immobilized.

Lever 5c also has a lug 5e extending in the direction of the axis of rotation of the door and has at the free end 5f of this lug 5e a stop 2c oriented towards the forearm 4c. This stop 2c locks the forearm 4c with respect to the lever 5c. As this lever 5c is itself blocked in relation to door 1a, stop 2c also makes it possible to block the forearm 4c in relation to door 1a by the combined sequence of the blocking means of lever 5c and forearm 4c. This sequence of blocking means simplifies the structure of the door by limiting in particular the number of fittings to be installed to block each element in relation to the door. Other means of blocking lever 5c in relation to door 1a can be used, such as a pin that fits into fitting 6a and lever 5c, or picking lever 5c on door 1a.

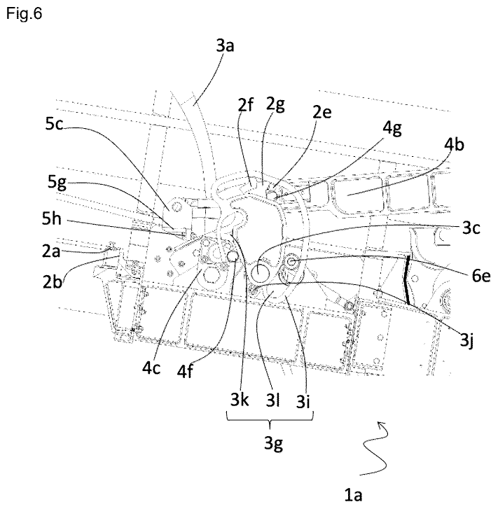

FIG. 6 shows a cross-sectional view of a handle linkage cam 3g as door 1a exits its frame. In this view, the locking mechanism 2 appears in a plane perpendicular to the door rotation axis 1d during the engagement/disengagement of door 1a, the inner handle 3a being then activated and door 1a rotating on itself. A portion of lever 5c is shown and shows the two surfaces 5g, 5h of lever 5c which go, respectively, to the contact of the two stops 2a, 2b of door 1a.

The 3G cam in section is shown with the door guides path 3L on the side 3i, as well as the forearm guide path 3K and the prohibition walls 2e, 2f on the other side 3h. The 3g cam is attached to the 3c axis of the handles 3a, 3b by a screw-nut assembly 3j. The rotation of a handle 3a, 3b generates in these conditions the rotation of the cam 3g which drives the door 1a by sliding the actuation roller 6e into the door guide path 31. In addition, this rotation of the cam 3g is controlled by the forearm 4c which is engaged in the guide path 3k by the control roller 4f of the forearm 4c.

The two prohibition walls 2e, 2f of the cam 3g are separated by a space 2g sized and located to let the arm roller 4g pass when the door 1a is totally disengaged or to engage the door 1a. During the engagement/disengagement of the door 1a, this arm roller 4g is in contact with the prohibition walls 2e, 2f. This contact then immobilizes the arm 4b and the door 1a, which cannot therefore make the circular translation until the handle 3 has reached the end of its travel. When handle 3 is at the end of its travel, the arm roller 4g is positioned at the entrance to the corridor formed by the prohibition walls 2e, 2f. These prohibition walls 2e, 2f ensure that door 1a is completely disengaged from door frame 1c and remains parallel to fuselage 1b following the full rotation of one of the door handles 3a, 3b and cam 3g before proceeding with the circular translation.

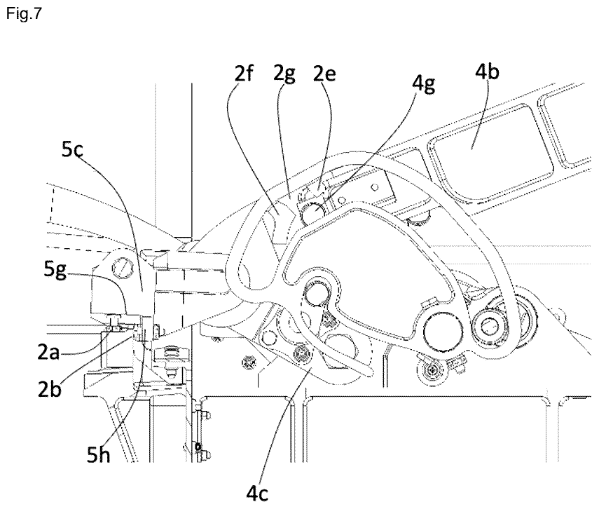

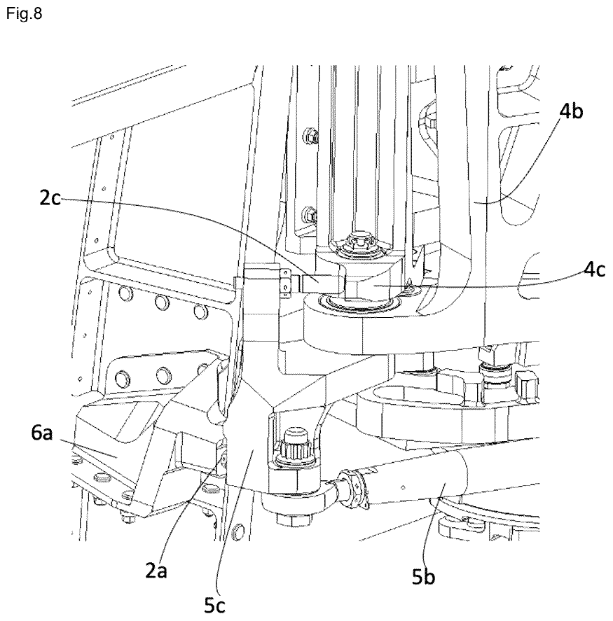

FIG. 7 and FIG. 8 show the configuration of the locking mechanism 2 at the end of the disengagement of door 1a, in particular the contact of the two door stops 2a, 2b on lever 5c in FIG. 7 and the contact of stop 2c of lever 5c on forearm 4c in FIG. 8. Also in FIG. 7, the arm roller 4g appears positioned at the entrance to the corridor formed by the 2nd and 2f prohibition walls 2e, 2f. Thus, by pushing door 1a to the exterior EXT of the aircraft, the arm roller 4g passes through the space 2g between the prohibition walls 2e, 2f then initiating the circular translation of door 1a. Similarly, when closing door 1a, a pull of door 1a towards the interior INT of the aircraft at the end of the circular translation brings the arm roller 4g into the space 2g between the interdiction walls 2e, 2f.

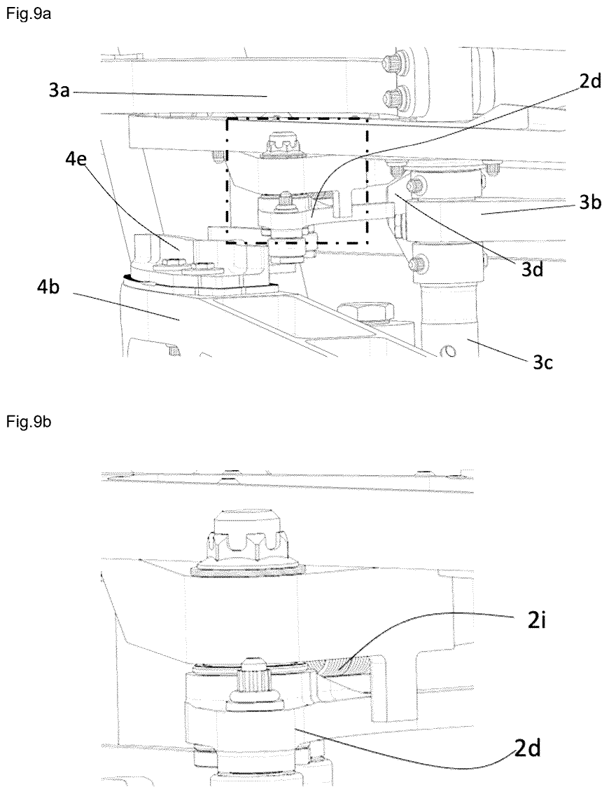

FIG. 9a illustrates the mechanical connection handle 2d rotated on the door 1a and resting against the stand 3d of the handle 3b during the circular translation. The guide ramp 4e of the stand 2d during the engagement/disengagement of door 1a of door frame 1c is fixed on the arm 4b. In addition, the stand 2d is held against the stop 3d of the stand by a means of returning, here a 2i tension spring visible in the enlargement in FIG. 9b, any other means of return can be used such as a piston, a hydraulic or pneumatic cylinder, or a torsion spring. In this embodiment, the stand 2d rests on the 3d stop of the 3b outer handle. Alternatively, the stand 3d can be resting directly on the outer handle 3b or the inside handle 3a.

The kinematics of the stand 2d are more precisely detailed successively in FIG. 10a, FIG. 10b and FIG. 10c.

In FIG. 10a, door 1a is closed and stand 2d is on ramp 4e. To disengage door 1a from door frame 1c, the outer handle 3b or inner handle 3a is rotated and the handle 2d remains moved away from the handle by the guide ramp 4e in response to the movement of door 1a, as shown in FIG. 10b. After the disengagement of door 1a in FIG. 10c, it is again parallel to fuselage 1b and the stand 2d comes out of the guide ramp 4a in the configuration shown in FIG. 9a and comes into contact with the stop 3d, thus preventing the rotation of the inner or outer handles. The end 2h of the stand 2d is then resting on the stop 3d of the stand. When the door is engaged, the contact between the stand 2d and the guide ramp 4e causes the handle 2d to rotate in such a way that its end 2h moves away from the stop 3d and allows the rotation of handle 3.

Blocking the handle can also be achieved by another means of blocking such as a hook or mechanical lock.

The circular translation of the door is achieved when the arm and connecting rod form a parallelogram. However, a trapezoidal installation of the arm and connecting rod is also possible and in the door opening kinematics thus realized, the door deviates in a controlled manner from its parallel orientation. The door locking mechanism can therefore be used generally in any kinematics that involve a door lock.

1. An assembly with a circular translation door locking mechanism (2) (1a) comprising;
a vehicle semi-plug door (1a) and a body from which is cut at least one opening creating a door frame (1c), the mechanism (2) having a handle (3) activating a rotation of the door (1a) on itself in the door frame (1c) and connecting the door (1a) to the door frame (1c) by two guide entities of the door in circular translation:
an arm-entity (4a) comprising an arm (4b) and a forearm (4c) rotating with respect to each other along an axis (4d) parallel to the axis of rotation (1d) of the door (1a), the arm (4b) and the forearm (4c) being connected respectively to the door frame (1c) and the door (1a),
a guide entity (5a) having a connecting rod (5b) and a lever (5c) rotating relative to each other along an axis (5d) parallel to the axis of rotation (1d) of the door (1a) and connected respectively to the door frame (1c) and to the axis (4d) of rotation of the arm entity (4a); and
the locking mechanism (2) being characterized in that it comprises at least one means of blocking the lever (5c) and the forearm (4c) in relation to the door (1a) as well as a blocking element of the handle (3) during the circular translation of the door.

2. The locking assembly according to claim 1, wherein the blocking of the lever (5c) and forearm (4c) with respect to the door (1a) is effected by at least two stops (2a, 2b) arranged on the door (1a).

3. The locking assembly according to claim 2, wherein the blocking of the lever (5c) is effected by the two stops (2a, 2b) arranged on the door (1a).

4. The locking assembly according to any one of claims 2, wherein the blocking of the forearm (4c) is effected by an additional stop (2c) arranged on the lever (5c).

5. The locking assembly according to claim 1, wherein the blocking element of the handle (3) is made by a mechanically connected handle (2d) rotatingly fixed on the door (1a) and resting against the handle (3) during the circular translation of the door (1a).

6. The locking assembly according to claim 5, wherein a traction device engages the stand (2d) against the handle (3) during the circular translation of the door (1a).

7. The locking assembly according to claim 6, wherein the traction device is a tension spring.

8. The locking assembly according to claims 5, wherein a handle (4e) is installed on the arm (4b) and moves the handle (2d) away from the handle (3) as the door (1a) rotates in the door frame (1c).

9. The locking assembly according to claim 1, wherein the handle is connected to the door (1a) by a two-sided cam (3g) which has on one of its sides (3i) at least one guide path (3k, 3l) and on the other side (3h) at least one prohibition wall (2nd, 2(f).

10. The locking assembly according to claim 9, wherein the cam (3g) has two guide paths (3k, 3l) of the forearm (4c) and the door (1a) respectively.

11. The locking assembly according to claim 10, wherein the forearm (4c) and the door (1a) each have a roller (4f, 6e) engaged in their respective guide path (3k, 3l).

12. The locking assembly according to claim 9, wherein the cam (3g) comprises two prohibition walls (2e, 2f).

13. The locking assembly according to claim 9, wherein the arm (4b) has an arm roller (4g) in contact with the prohibition walls (2e, 2f) during the rotation of the door (1a).

14. The locking assembly according to claim 13, wherein the prohibition walls (2e, 2f) are separated by a space (2g) sized to allow the arm roller (4g) to pass.

15. The locking assembly according to claim a, wherein the vehicle is an aircraft having a fuselage serving as a body from which the door frame is cut.
